(19) United States
(12) Patent Application Publication
(10) Pub. No.: US 2008/0283459 A1
(43) Pub. Date: Nov. 20, 2008

(54) PURIFICATION CARRIER INPUT STRUCTURE OF A SEWAGE SCUM REMOVING UNIT

(76) Inventor: CHENG-HUA SHEN, Taipei county (TW)

Correspondence Address: CHARLES C.H. WU, 98 DISCOVERY, IRVINE, CA, 92618-3105, US

(21) Appl. No.: 11/962,876

(22) Filed: Dec. 21, 2007

(30) Foreign Application Priority Data
May 18, 2007 (TW) 096208151

(51) Int. Cl. C02F 1/24

(52) U.S. Cl. 210/221.1

(57) ABSTRACT

An improved structure of purification carrier input of a sewage scum removing unit includes a tank provided with a water inlet to introduce sewage into the tank; a water outlet disposed at a predetermined location on the tank to lead sewage out of the tank; and a carrier introduction end disposed in the peripheral of the water inlet on the tank to introduce polymer carrier to clean the sewage; the water inlet is connected to an air water mixing device for the sewage to first go through air bulbs addition process before entering into the tank to get mixed with the polymer carrier for correcting the problem that molecular structure of the polymer carrier is vulnerable to be destructed in the course of pumping air bulbs into the sewage as found with the prior art.

### BACKGROUND OF THE INVENTION

(a) Field of the Invention

The present invention is related to an improved structure of a purification carrier input of a sewage scum removing unit, and more particularly, to an organized layout configuration of an improved installation structure to achieve upgraded cleaning function by the purification carrier.

(b) Description of the Prior Art

A tank to accommodate sewage is usually provided in a structural configuration of sewage scum removing unit of the prior art. Air bulbs are pumped into the tank for pollutants in the sewage to get attached to those air bulbs and float up to surface level and to form a scum suspension layer, and the scum suspension layer is then removed. This sewage disposal method allows recycled use of water resources, reduction of water consumption, and thus saving water resources; therefore, this method is massively applied in aquaculture industry, sewage process plant, and secondary use of consumer water.

It is understandable that additional to the tank and the structure to pump into air bulbs as described above, a mixing device is further disposed to intensify contact of air bulbs with pollutants for the general scum removing unit to more effectively remove pollutants in the water; furthermore, the sewage to be processed may be added into a material that is capable of absorbing contaminated substances, e.g., a polymer carrier to absorb toxic substance or a specific pollutant; and as aided by the mixing device, the capacity of absorption of pollutants in the water is improved to avail cleaner water for secondary use.

In a typical sewage treatment procedure, an air-liquid mixing device is provided to pump air bulbs into the water or a mixing device is operated to pat the water for pumping air into the sewage; and the polymer carrier to clean pollutants in water functions to absorb specific pollutants in the sewage or to create a structure that is capable of retrieving air bulbs in water thus to form jointly with air bulbs a structure that is capable of removing particle pollutants. However, the polymer carrier is of a comparatively weak structure and the cleaning structure created in the water would be easily destructed in the course of generating air bulbs in the sewage or patting the water to compromise the function of absorbing pollutant otherwise the carrier is expected to function. Should the sewage scum removing unit of the prior art be redesigned to give it different organizational layout, the cleaning results provided by the polymer carrier will be improved, thus to further improve the overall efficiency of sewage filtration.

### SUMMARY OF THE INVENTION

The primary purpose of the present invention is to provide an improved structure to input purification carrier for a sewage scum removing unit by having the purification carrier disposed in such a way that the purification carrier is added into the sewage only upon completing the air liquid mixing operation in a filtration process so that the purification carrier would be able to bring its absorption efficacy into full play under a mild current.

To achieve the purpose, the improved structure of the present invention includes a first tank having a water inlet to introduce in sewage disposed beneath the first tank; a water outlet disposed at a predetermined location on the first tank to lead sewage out of the tank and a first conduit is disposed to lead the sewage to a second tank for curing; a carrier introduction end is disposed to the first tank at where in the peripheral to the water inlet of the tank for introducing in polymer carrier to clean the sewage; the water inlet is connected to an air water mixing device for the sewage to first go through an air bulb addition process before being admitted to mix with the polymer carrier to correct the flaw that molecular structure is vulnerable to be destructed by pressure or externally applied force as found with the prior art.

### BRIEF DESCRIPTION OF THE DRAWINGS

FIG. 1 is a perspective view showing a preferred embodiment of the present invention.

FIG. 2 is a schematic view showing a construction of a local part of the preferred embodiment of the present invention.

FIG. 3 is schematic view showing an operating status of the preferred embodiment of the present invention.

### DETAILED DESCRIPTION OF THE PREFERRED EMBODIMENTS

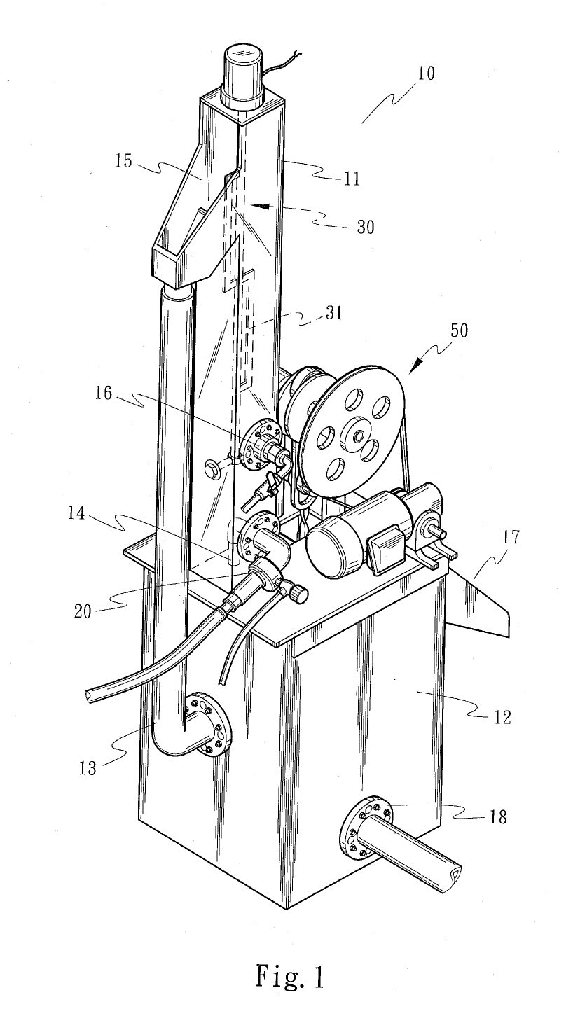

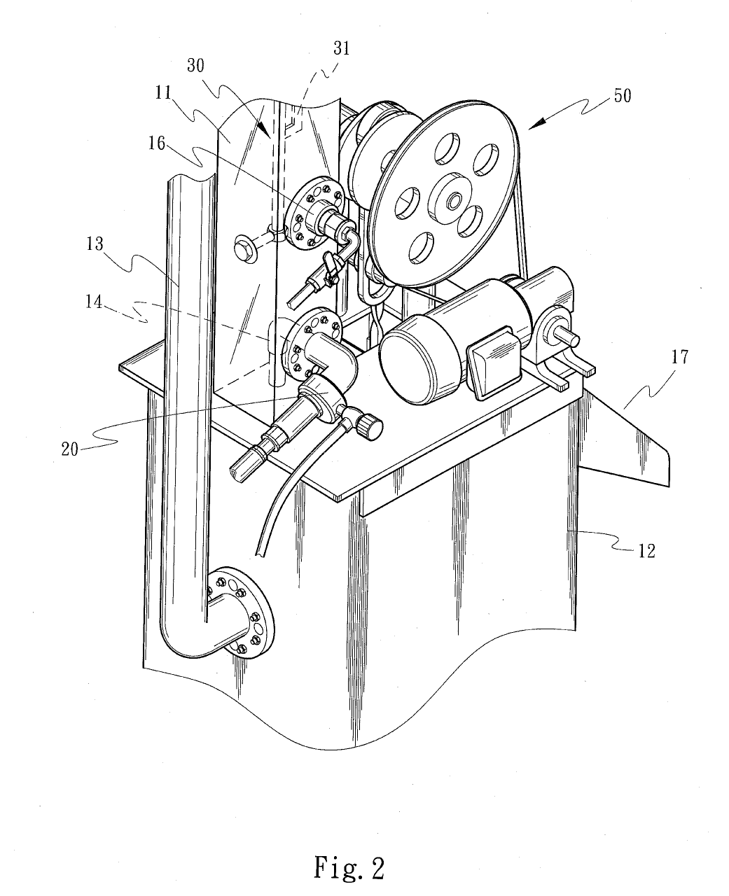

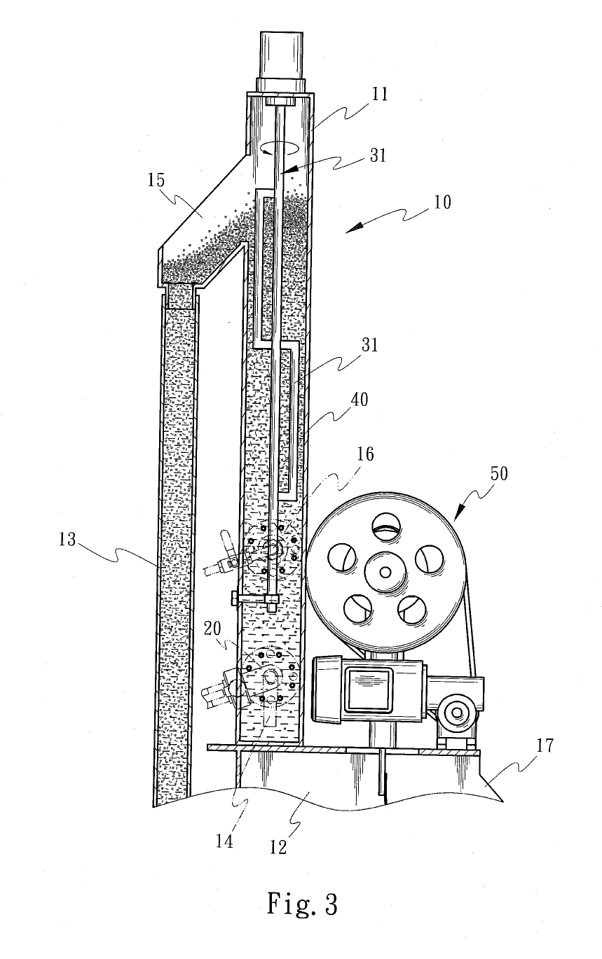

Referring to FIGS. 1 and 2, a preferred embodiment of the present invention is essentially comprised of a main unit 10 containing a first tank 11 having below it disposed with a water inlet 14 to introduce in sewage; and a water outlet disposed at a predetermined location to the first tank 11 to lead sewage out of the first tank 11 and a conduit 13 is disposed to lead sewage to a second tank 12 for curing; wherein a carrier introduction end 16 is disposed to the first tank 11 and the carrier introduction end is located at where in the peripheral of the water inlet 14 of the first tank; and in the preferred embodiment, the carrier introduction end 16 is disposed at where above the water inlet 14 to introduce in polymer carrier 40 (as illustrated in FIG. 3) for cleaning the sewage; the water inlet 14 is connected to an air liquid mixing device 20 for the sewage to first go through a mixing process with air before being admitted into the first tank to get mixed with the polymer carrier 40 for correcting a flaw that molecular structure of the carrier in the course of adding in air bulbs is vulnerable to be destructed by pressure or externally applied force as found with the prior art. In another preferred embodiment of the present invention, the water inlet is connected to a tank structure, which contains a space to accommodate the sewage and is provided with an air bulb generator to pump air bulbs into the sewage.

In the preferred embodiment, the first tank 11 is made in a form indicating a smaller diameter, long and narrow body; and to facilitate uniform distribution of air bulbs and contamination removing substance in the sewage, a regulation device 30 containing a mixer is disposed in the first tank 11 so that when the sewage flows through a route created by a narrow space of the first tank 11, the regulation device 30 will sufficiently and uniformly disperse air bulbs and pollutant removing substance in the sewage before being discharged out of the water outlet 15 disposed on an upper portion of the first tank 1.

As illustrated in FIG. 3 showing sewage purification process and filtration means of the present invention, the sewage containing air bulbs flows through a bottom of the first tank 11 as introduced in by the water inlet 14, a water level (or then existing sewage) in the first tank 11 is building up; and in the process of building up the polymer carrier 40 introduced by the carrier introduction end 16 at where above the water inlet 14 is mixed with the sewage containing air bulbs; furthermore, the mixing device 31 continuously blends the sewage at a proper revolution speed for achieving uniform mixing among sewage, air bulbs, and polymer carrier 40 while allowing sufficient time for the air bulbs and polymer carrier to absorb air bulbs and pollutants in the water in the long and narrow flowing path of the first tank 11.

Once the water level rises up to approach a top position of the first tank 11, the sewage flows out of the water outlet 15 to enter into the conduit 13; and the sewage containing fully mixed air bulbs and polymer carrier 40 is led through the conduit 13 into the second tank 12, which in a wider and more spacious profile or construction. After having sufficient mixing with the polymer carrier 40 absorbed with air bulbs, the sewage gradually floats and coalesces towards surface level in the second tank 12 while the purified water is settling down in the second tank 12. The polymer carrier absorbed with air bulbs and pollutants is gradually overflowing out of a scum removal trough 17 disposed to upper portion of the second tank 12 or externally scraped with an aid from a scarping device 50 disposed on the second tank. Meanwhile, the descending clean water is led out from a water outlet 18 disposed at a lower end of the second tank 12 for use.

The sewage and those substances used to remove foreign matters in sewage water are fully regulated before being introduced into the second tank 20 for curing to separate water from pollutants after sedimentation. Substantially, a structure to supply and operate the polymer carrier 40 is set to be executed after air bulbs are pumped into the sewage so to free the polymer carrier 40 from being affected by the pressure produced upon pumping air bulbs into the sewage or interfered by external force applied in the course of patting the water to damage the structure of the polymer carrier 40 mixed in the sewage and further to compromise efficiency of the polymer carrier 40 to absorb pollutants.

Accordingly, the improved structure of a purification carrier input for a sewage scum removing unit of the present invention by redesigned the layout configuration for the introduction end 16 of the carrier does correct the problems of damaged structure of the polymer carrier due to blending and frustrated cleaning efficiency as found with the prior art to realize the purpose of upgraded pollutant removing results in showing a very significant progress.

However, it is to be noted that the preferred embodiments disclosed in the specification and the accompanying drawings are not limiting the present invention; and that any construction, installation, or characteristics that is same or similar to that of the present invention should fall within the scope of the purposes and claims of the present invention.

I claim:

1. A purification carrier input improved structure of a sewage scum removing unit comprising a main unit containing a first tank having a water inlet disposed beneath the first tank to lead sewage into the first tank; a water outlet disposed at a predetermined location on the first tank to lead sewage out of the first tank; an air water mixing device being disposed before the water inlet; and a carrier introduction end being disposed after the air water mixing device to lead in polymer carrier for cleaning purpose.

2. The purification carrier input improved structure of a sewage scum removing unit as claimed in claim 1, wherein both of the air water mixing device and the water inlet are connected to each other.

3. The purification carrier input improved structure of a sewage scum removing unit as claimed in claim 1 or 2, wherein the carrier introduction end is disposed at where in the vicinity of the water inlet to the first tank.

4. The purification carrier input improved structure of a sewage scum removing unit as claimed in claim 1, wherein the main unit is disposed with a water tank structure; the water tank contains a space to accommodate sewage and a device to generate air bulbs in the water tank; and the water tank is connected to the water inlet.

5. The purification carrier input improved structure of a sewage scum removing unit as claimed in claim 2, wherein the main unit is disposed with a water tank structure; the water tank contains a space to accommodate sewage and a device to generate air bulbs in the water tank; and the water tank is connected to the water inlet.

6. The purification carrier input improved structure of a sewage scum removing unit as claimed in claim 3, wherein the main unit is disposed with a water tank structure; the water tank contains a space to accommodate sewage and a device to generate air bulbs in the water tank; and the water tank is connected to the water inlet.

7. The purification carrier input improved structure of a sewage scum removing unit as claimed in claim 1, wherein a conduit is connected to the water outlet; and the conduit leads sewage into a second tank.

8. The purification carrier input improved structure of a sewage scum removing unit as claimed in claim 2, wherein a conduit is connected to the water outlet; and the conduit leads sewage into a second tank.

9. The purification carrier input improved structure of a sewage scum removing unit as claimed in claim 3, wherein a conduit is connected to the water outlet; and the conduit leads sewage into a second tank.

10. The purification carrier input improved structure of a sewage scum removing unit as claimed in claim 4, wherein a conduit is connected to the water outlet; and the conduit leads sewage into a second tank.

11. The purification carrier input improved structure of a sewage scum removing unit as claimed in claim 5, wherein a conduit is connected to the water outlet; and the conduit leads sewage into a second tank.

12. The purification carrier input improved structure of a sewage scum removing unit as claimed in claim 7, wherein a scum removal trough is disposed to an upper portion of the second tank.

13. The purification carrier input improved structure of a sewage scum removing unit as claimed in claim 8, wherein a scum removal trough is disposed to an upper portion of the second tank.

14. The purification carrier input improved structure of a sewage scum removing unit as claimed in claim 9, wherein a scum removal trough is disposed to an upper portion of the second tank.

15. The purification carrier input improved structure of a sewage scum removing unit as claimed in claim 10, wherein a scum removal trough is disposed to an upper portion of the second tank.

16. The purification carrier input improved structure of a sewage scum removing unit as claimed in claim 1, wherein a regulation unit is disposed to the first tank; the regulating unit contains a mixing member vertically disposed in the first tank.

17. The purification carrier input improved structure of a sewage scum removing unit as claimed in claim 2, wherein a regulation unit is disposed to the first tank; the regulating unit contains a mixing member vertically disposed in the first tank.

18. The purification carrier input improved structure of a sewage scum removing unit as claimed in claim 3, wherein a regulation unit is disposed to the first tank; the regulating unit contains a mixing member vertically disposed in the first tank.

19. The purification carrier input improved structure of a sewage scum removing unit as claimed in claim 4, wherein a regulation unit is disposed to the first tank; the regulating unit contains a mixing member vertically disposed in the first tank.

20. The purification carrier input improved structure of a sewage scum removing unit as claimed in claim 7, wherein a regulation unit is disposed to the first tank; the regulating unit contains a mixing member vertically disposed in the first tank.

21. The purification carrier input improved structure of a sewage scum removing unit as claimed in claim 12, wherein a regulation unit is disposed to the first tank; the regulating unit contains a mixing member vertically disposed in the first tank.

22. The purification carrier input improved structure of a sewage scum removing unit as claimed in claim 1, wherein the first tank is made in a smaller diameter with long and narrow profile.

23. The purification carrier input improved structure of a sewage scum removing unit as claimed in claim 2, wherein the first tank is made in a smaller diameter with long and narrow profile.

24. The purification carrier input improved structure of a sewage scum removing unit as claimed in claim 3, wherein the first tank is made in a smaller diameter with long and narrow profile.

25. The purification carrier input improved structure of a sewage scum removing unit as claimed in claim 4, wherein the first tank is made in a smaller diameter with long and narrow profile.

26. The purification carrier input improved structure of a sewage scum removing unit as claimed in claim 7, wherein the first tank is made in a smaller diameter with long and narrow profile.

27. The purification carrier input improved structure of a sewage scum removing unit as claimed in claim 12, wherein the first tank is made in a smaller diameter with long and narrow profile.

28. The purification carrier input improved structure of a sewage scum removing unit as claimed in claim 16, wherein the first tank is made in a smaller diameter with long and narrow profile.

29. The purification carrier input improved structure of a sewage scum removing unit as claimed in claim 7, wherein a scraping device is disposed to the second tank.

30. The purification carrier input improved structure of a sewage scum removing unit as claimed in claim 12, wherein a scraping device is disposed to the second tank.

31. The purification carrier input improved structure of a sewage scum removing unit as claimed in claim 16, wherein a scraping device is disposed to the second tank.

32. The purification carrier input improved structure of a sewage scum removing unit as claimed in claim 17, wherein a scraping device is disposed to the second tank.

33. The purification carrier input improved structure of a sewage scum removing unit as claimed in claim 18, wherein a scraping device is disposed to the second tank.

34. The purification carrier input improved structure of a sewage scum removing unit as claimed in claim 19, wherein a scraping device is disposed to the second tank.

35. The purification carrier input improved structure of a sewage scum removing unit as claimed in claim 20, wherein a scraping device is disposed to the second tank.

36. The purification carrier input improved structure of a sewage scum removing unit as claimed in claim 21, wherein a scraping device is disposed to the second tank.

37. The purification carrier input improved structure of a sewage scum removing unit as claimed in claim 22, wherein a scraping device is disposed to the second tank.

38. The purification carrier input improved structure of a sewage scum removing unit as claimed in claim 23, wherein a scraping device is disposed to the second tank.

39. The purification carrier input improved structure of a sewage scum removing unit as claimed in claim 24, wherein a scraping device is disposed to the second tank.
